(19) United States
(12) Patent Application Publication
(10) Pub. No.: US 2011/0219589 A1
(43) Pub. Date: Sep. 15, 2011

(54) Clip Device

(75) Inventor: Masashi Yoneyama, Tokyo (JP)

(73) Assignee: General Research of Electronics, Inc., Tokyo (JP)

(21) Appl. No.: 12/830,757

(22) Filed: Jul. 6, 2010

(30) Foreign Application Priority Data
Mar. 11, 2010 (JP) 2010-54890

(51) Int. Cl. F16B 2/22

(52) U.S. Cl. 24/530

(57) ABSTRACT

The present invention provides a clip device capable of reducing process steps for the work of connecting a base member, an opening/closing member and a double torsion spring to one another. This clip device is configured in such a manner that the base member and the opening/closing member are connected via both shaft bearings and a support shaft, and a holding portion is biased apart by the double torsion spring provided between the base member and the opening/closing member. The base member has a pair of the shaft bearings which compresses and holds the double torsion spring therebetween, positioning pieces which position the double torsion spring with respect to a direction parallel to the base member within directions orthogonal to the axial core directions of wound portions of the double torsion spring, and holes which are respectively defined between the shaft bearings and the positioning pieces and cause the tips of the double torsion spring to be inserted therethrough.

### BACKGROUND OF THE INVENTION

1. Field of the Invention

The present invention relates to a clip device wherein a base member and an opening/closing member are connected via both shaft bearings and a support shaft and a holding portion is biased apart by a resiliently biased member provided between the base member and the opening/closing member.

2. Description of the Related Art

As a related art of this type of clip device, there has been known a hair-holding clip wherein a double torsion type coil spring is pivotally supported between an upper holding body and a lower holding body so that the upper holding body and the lower holding body are superimposed on each other, and a central fold-back portion of the coil spring is brought into abutment against one of upper and lower clip portions and both winding ends of the coil spring are brought into abutment against the other thereof (refer to, for example, a patent document 1 (Japanese Patent Application No. Hei 8(1996)-341).

The double torsion type coil spring mounted to the hair-holding clip, i.e., the double torsion spring has fixed portions formed at both ends thereof and brought into abutment against the lower holding portion, i.e., base member, wound portions formed at one ends of the fixed portions, and the central fold-back portion, i.e., abutment portion which connects these wound portions and are brought into abutment against the upper holding body, i.e., opening/closing member. In the hair-holding clip, a support shaft is inserted into axial cores of through holes of shaft bearings of the base member, through holes of shaft bearings of the opening/closing member and the wound portions of the double torsion spring to thereby bring the base member, opening/closing member and double torsion spring to an integral type.

Upon assembly work of the hair-holding clip device according to the related art, which has been disclosed in the patent document 1, the double torsion spring is first disposed between the base member and the opening/closing member, and the abutment portion of the double torsion spring is brought into abutment against the opening/closing member and the tips of the fixed portions of the double torsion spring are brought into abutment against the base member. Then, the base member and the opening/closing member are compressed to allow the axial cores of the through holes of the shaft bearings of the base member, the through holes of the shaft bearings of the opening/closing member and the wound portions of the double torsion spring to coincide with one another as viewed in the axial core direction. At this time, this assembly work involves difficult work taken for causing the support shaft to be inserted into through holes of mounting pieces of the base member, through holes of mounting pieces of the opening/closing member and the rotational axes of the wound portions of the double torsion spring with another of both hands while the base member and the opening/closing member are being compressed against the resistance force of the double torsion spring with one of both hands. Alternatively, the assembly work needs a dedicated jig.

Thus, since the work is performed in a state in which the double torsion spring has been held down with one hand via the base member and the opening/closing member, the double torsion spring is held in an unstable state of being easy to shift down between the base member and the opening/closing member. There is therefore a case in which the transfer of force to the double torsion spring is not successfully done uniformly in the direction of the width of the base member. Since, in this case, the wound portions of the double torsion spring are displaced in position and the axial cores of the wound portions do not coincide with each other as viewed in the axial core direction, it becomes difficult to allow the support shaft to be inserted into the axial cores of the wound portions of the double torsion spring. As a result, the work of coupling the base member, opening/closing member and double torsion spring becomes cumbersome.

### SUMMARY OF THE INVENTION

The present invention has been made in view of the above situation of such a related art. The present invention is to provide a clip device capable of reducing work process steps for connecting a base member, an opening/closing member and a double torsion spring to one another.

In order to achieve the above object, there is provided a clip device according to the present invention, comprising:
a base member;
an opening/closing member;
pairs of shaft bearings;
a support shaft;
a resiliently biased member provided between the base member and the opening/closing member; and
a holding portion biased apart by the resiliently biased member,
wherein the base member and the opening/closing member are connected to each other via the shaft bearings and the support shaft,
wherein the resiliently biased member comprises a double torsion spring having wound portions, and
wherein the base member has a pair of the shaft bearings which compresses and holds the double torsion spring between the shaft bearings, positioning pieces which position the double torsion spring with respect to a direction parallel to the base member within directions orthogonal to axial core directions of the wound portions, and holes which are respectively defined inside the pair of shaft bearings and cause the tips of the double torsion spring to be inserted therethrough.

The clip device according to the present invention is provided wherein in the present invention, the base member comprises a casing with the opening/closing member attached thereto.

Since the clip device of the present invention is capable of holding the double torsion spring in a predetermined position of the base member in one process step, work process steps can be reduced significantly.

Other features and advantages of the present invention will become apparent upon a reading of the attached specification.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view showing a configuration of a first embodiment of a clip device according to the present invention;

FIG. 2 is a view of the first embodiment as seen from its front;

FIG. 3 is a view of the first embodiment as seen from its side; and

FIG. 4 is a perspective view illustrating a configuration of a second embodiment of a clip device according to the present invention.

### DETAILED DESCRIPTION OF THE PREFERRED EMBODIMENTS

Modes for carrying out the present invention will be explained hereinafter with reference to the accompanying drawings.

### First Embodiment

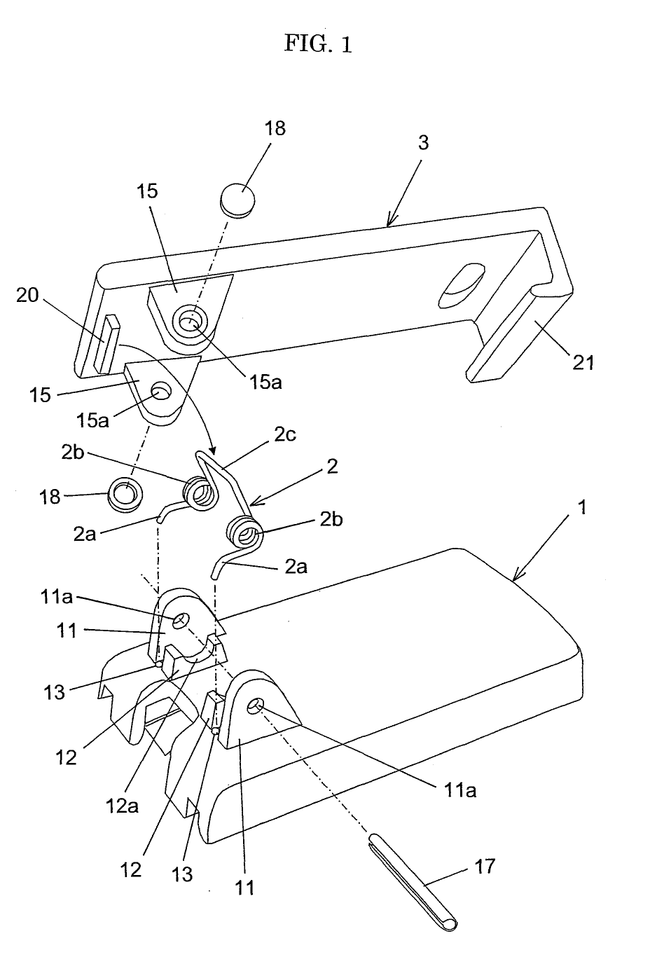

A first embodiment of a clip device according to the present invention is mounted to a casing such as an electronic device. As show in FIGS. 1 through 3, the first embodiment is equipped with a base member 1 attached to an unillustrated casing, an opening/closing member 3 whose one end is connected thereto via a support shaft 17, and a resiliently biased member disposed between the base member 1 and the opening/closing member 3 and interposed on the support shaft 17. The resiliently biased member is comprised of a double torsion spring. The double torsion spring 2 has fixed portions 2a formed at both ends thereof, wound portions 2b each formed at one end of the fixed portion 2a, and an abutment portion 2c which connects these wound portions 2b to each other and is brought into abutment against the opening/closing member 3.

The base member 1 has a pair of first shaft bearings 11 which compresses and holds the double torsion spring 2 therebetween, positioning pieces 12 which position the double torsion spring 2 with respect to a direction parallel to the base member 11 within directions orthogonal to the axial core directions of the wound portions 2b of the double torsion spring 2, and holes 13 which are defined inside the pair of first shaft bearings 11, e.g., between the first shaft bearings 11 and the positioning pieces 12 respectively and cause the tips of the fixed portions 2a of the double torsion spring 2 to be inserted therethrough. A spacing defined between the pair of first shaft bearings 11 is set slightly smaller than the size of a width extending along the axial core direction of each wound portion 2b of the double torsion spring 2.

Each of the positioning pieces 12 has a fitting portion 12a which is formed in a semicircular arc-shaped manner along the shape of the wound portion 2b of the double torsion spring 2 and fits the wound portion 2b thereon. The opening/closing member 3 includes a pair of second shaft bearings 15 disposed outside the pair of first shaft bearings 11 and opposite to the pair of first shaft bearings 11, respectively, and a support piece 20 which supports the abutment portion 2c of the double torsion spring 2. Each of the first shaft bearings 11 of the base member 1 has a through hole 11a which extends along the axial core direction of the wound portion 2b of the double torsion spring 2. Each of the second shaft bearings 15 of the opening/closing member 3 has a through hole 15a which extends along the axial core direction of the wound portion 2b. Namely, the positions of these through holes 11a and 15a are set in such a manner that the axial cores of the wound portions 2b and the axial cores of the through holes 11a and 15a coincide with one another. Incidentally, the opening/closing member 3 has one end of both ends, lying on the side of opening/closing thereof relative to the base member 1, said one end being inverted U-shaped, and a holding portion 21 which clips or holds an object placed between the base member 1 and the opening/closing member 3.

The first embodiment of the present invention has the support shaft 17 inserted into the axial cores of the through holes 11a and 15a of the first and second shaft bearings 11 and 15 and the axial cores of the wound portions 2b of the double torsion spring 2, and caps 18 for covering the through holes 15a in a state in which the support shaft 17 is being inserted into the axial cores of the through holes 11a and 15a and the wound portions 2b. The support shaft 17 is shaped in cylindrical form and acts as an axis of an air core with a cleavage being defined therein along its axial core direction. This air core is used to cause an axial-part mounting jig bar fitted to the hole diameter of the corresponding shaft to pass therethrough.

The operation of the first embodiment of the clip device according to the present invention will next be explained.

In the first embodiment of the present invention, when the double torsion spring 2 is disposed between the first shaft bearings 11 mounted to the base member 1 where the base member 11, double torsion spring 2 and opening/closing member 3 are connected by connecting members, the spacing defined between the pair of first shaft bearings 11 is set slightly smaller than the size of the width extending along the axial core direction of each wound portion 2b of the double torsion spring 2. Therefore, the double torsion spring 2 is compressed by the first shaft bearings 11 and held so as not to move in the direction of the width of the base member 1.

When, at this time, the wound portions 2b of the double torsion spring 2 are fitted to their corresponding semicircular arc-shaped fitting portions 12a formed in the positioning pieces 12 of the base member 1, the double torsion spring 2 is positioned by the positioning pieces 12 with respect to the direction parallel to the base member 1 within the directions orthogonal to the axial core directions of the wound portions 2b. Thus, the wound portions 2b of the double torsion spring 2 are held in a state in which their axial cores have coincided with each other. Further, since the positions of the through holes 11a of the first shaft bearings 11 are set in such a manner that the axial cores of the wound portions 2b and the axial cores of the through holes 11a coincide with one another when the wound portions 2b of the double torsion spring 2 are fitted to their corresponding fitting portions 12a of the positioning pieces 12, the wound portions 2b are held by the positioning pieces 12 and at the same time the axial cores of the wound portions 2b and the axial cores of the through holes 11a coincide with one another.

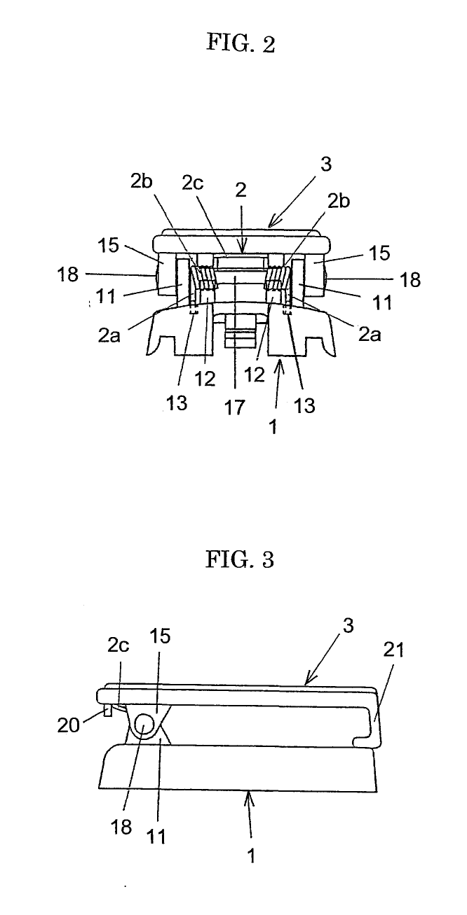

The tips of the wound portions 2a of the double torsion spring 2 are inserted into their corresponding holes 13 defined between the first shaft bearings 11 and the positioning pieces 12, so that the wound portions 2b are respectively fixed so as not to be disengaged from the fitting portions 12a of the positioning pieces 12. In this state, the support piece 20 of the opening/closing member 3 is brought into abutment against the abutment portion 2c of the double torsion spring 2 to compress the double torsion spring 2, and the support shaft 17 is inserted into the axial cores of the through holes 11a and 15a of the first and second shaft bearings 11 and 15 and those of the wound portion 2b. Then, as shown in FIGS. 2 and 3, the through holes 15a are covered with the caps 18 respectively.

In the first embodiment of the present invention configured in this way, upon the work of connecting the base member 1, double torsion spring 2 and opening/closing member 3 to one another, a simple work to compress and hold the double torsion spring 2 between the first shaft bearings 11 of the base member 11 and fit the wound portions 12a of the double torsion spring 2 to the fitting portions 12a of the positioning pieces 12 of the base member 1 is merely carried, thereby making it possible to dispose the double torsion spring 2 in such a manner that the axial cores of the wound portions 2 and the axial cores of the through holes 11a of the first shaft bearings 11 coincide with one another.

Even though, in order to cause the axial cores of the through holes 15a of the second shaft bearings 15 to coincide with the axial cores of the wound portions 2b respectively, the double torsion spring 2 is held down on the base member 1 by means of the opening/closing member 3 in a state in which the support piece 20 of the opening/closing member 3 supports the abutment portion 2c of the double torsion spring 2, the double torsion spring 2 is held by the first shaft bearings, 11, the fitting portions 12a of the positioning pieces 12 and the holes 13 and thereby kept in a stable state. It is therefore possible to easily cause the support shaft 17 to be inserted into the axial cores of the through holes 11a and 15a of the first and second shaft bearings 11 and 15 and the axial cores of the wound portions 2b without causing position displacements of the wound portions 2b. Thus, process steps for the work of connecting the base member 1, the double torsion spring 2 and the opening/closing member 3 can be reduced, thereby making it possible to perform assembly work easily.

In the first embodiment of the present invention, since the support shaft 17 is shaped in cylindrical form and formed with the cleavage along its axial core direction so as to have resilience, the support shaft 17 is fixed so as not to move by its resilience when the support shaft 17 is inserted into the axial cores of the through holes 11a and 15a of the first and second shaft bearings 11 and 15 and the axial cores of the wound portions 2b. It is thus possible to realize a stable structure of the clip device.

In the first embodiment of the present invention as well, the design of the clip device can be improved by covering the through holes 15a with the caps 18 in the state in which the support shaft 17 has been inserted into the axial cores of the through holes 11a and 15a and the wound portions 2b.

### Second Embodiment

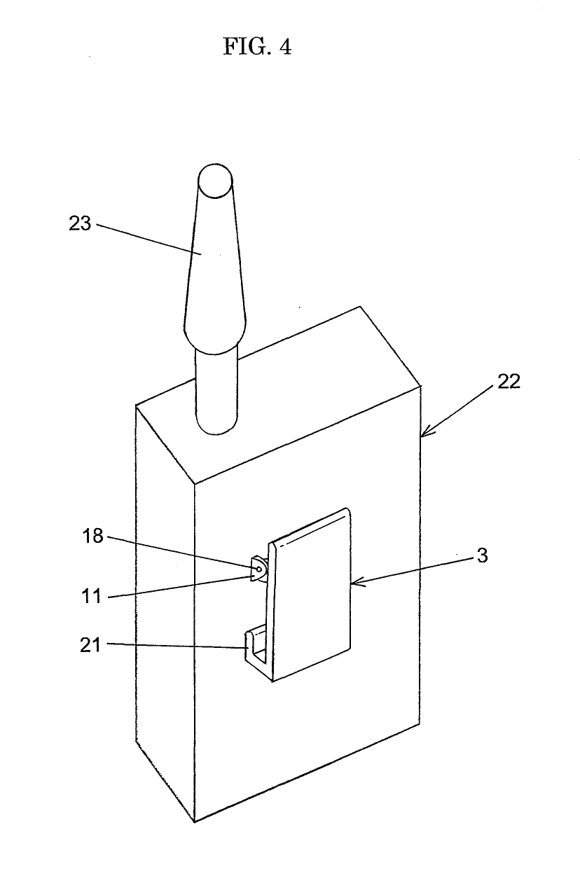

FIG. 4 is a perspective view showing a configuration of a second embodiment of a clip device according to the present invention.

The second embodiment of the present invention is different from the first embodiment in that though the first embodiment has explained the case where the base member 1 is mounted to the unillustrated casing such as the electronic device, a base member 1 comprises a casing 22 with an opening/closing member 3 attached thereto in the second embodiment as shown in FIG. 4. The casing 22 has an antenna 23 which receives radio waves at its upper surface. The second embodiment is similar to the first embodiment in other configuration.

In the second embodiment of the present invention configured in this way, the base member 1 comprises the casing 22 to which the opening/closing member 3 is attached, and the opening/closing member 3 and double torsion spring 2 may simply be mounted directly to the casing 22. A work process for mounting the base member 1 to the casing 22 becomes therefore unnecessary, and assembly man-hours of the device can hence be reduced. It is thus possible to enhance the efficiency of assembly work.

Incidentally, although the description has been made of the case where each of the first and second embodiments of the present invention has the support shaft 17 inserted into the axial cores of the through holes 11a and 15a of the first and second shaft bearings 11 and 15 and the axial cores of the wound portions 2b of the double torsion spring 2, and the caps 18 which cover the through holes 15a in the state in which the support shaft 17 has been inserted into the axial cores of the through holes 11a and 15a and the wound portions 2b, it may have bolts and nuts, for example, instead of the support shaft 17 and the caps 18.

While the preferred forms of the present invention have been described, it is to be understood that modifications will be apparent to those skilled in the art without departing from the spirit of the invention. The scope of the invention is to be determined solely by the following claims.

What is claimed is:

1. A clip device comprising:
a base member;
an opening/closing member;
pairs of shaft bearings;
a support shaft;
a resiliently biased member provided between the base member and the opening/closing member; and
a holding portion biased apart by the resiliently biased member,
wherein the base member and the opening/closing member are connected to each other via the shaft bearings and the support shaft,
wherein the resiliently biased member comprises a double torsion spring having wound portions, and
wherein the base member has a pair of the shaft bearings which compresses and holds the double torsion spring between the shaft bearings, positioning pieces which position the double torsion spring with respect to a direction parallel to the base member within directions orthogonal to axial core directions of the wound portions, and holes which are respectively defined inside the pair of shaft bearings and cause the tips of the double torsion spring to be inserted therethrough.

2. The clip device according to claim 1, wherein the base member comprises a casing with the opening/closing member attached thereto.
